(19) United States
(12) Patent Application Publication
(10) Pub. No.: US 2024/0311625 A1
(43) Pub. Date: Sep. 19, 2024

(54) HARDWARE ACCELERATION APPARATUS AND ACCELERATION METHOD FOR NEURAL NETWORK COMPUTING

(71) Applicant: CANAAN BRIGHT SIGHT CO., LTD, Beijing (CN)

(72) Inventors: Zhaofei PU, Beijing (CN); Nangeng ZHANG, Beijing (CN)

(21) Appl. No.: 18/576,819

(22) PCT Filed: Jan. 20, 2022
(86) PCT No.: PCT/CN2022/073041

§ 371 Date: Jan. 5, 2024

(30) Foreign Application Priority Data
Jul. 8, 2021 (CN) 202110772340.6

(51) Int. Cl. G06N 3/063

(52) U.S. Cl. CPC G06N 3/063

(57) ABSTRACT

Disclosed are a hardware acceleration apparatus and an acceleration method for neural network computing. The hardware acceleration apparatus comprises a memory module, a parsing module and a plurality of functional modules, wherein the memory module is used for caching data required by neural network computing; the parsing module is used for receiving an instruction sequence that is predetermined according to the size of the memory module and the data required by neural network computing, for parsing the instruction sequence so as to obtain a plurality of types of operation instructions, and for issuing a corresponding type of operation instruction to each functional module; and each functional module is used for executing a corresponding operation of neural network computing in response to the reception of the corresponding type of operation instruction. By using the hardware acceleration apparatus for neural network computing, the universality of the hardware acceleration apparatus can be improved.

This application claims priority to Chinese Patent Application No. 202110772340.6, filed on Jul. 8, 2021 and entitled “HARDWARE ACCELERATION APPARATUS AND ACCELERATION METHOD FOR NEURAL NETWORK COMPUTING”, the entire disclosure of which is incorporated herein by reference.

### TECHNICAL FIELD

The present disclosure relates to the field of neural network computation, in particular to a hardware acceleration apparatus and an acceleration method for a neural network computation.

### BACKGROUND

This section is intended to provide background or context to embodiments of the present disclosure as set forth in claims. What is described herein is not admitted to be prior art by virtue of its inclusion in this section.

Neural networks have been widely used in various computer vision applications, such as image classification, face recognition and the like. Currently, due to the large amount of data movement and the computational complexities in neural network computations, most of hardware acceleration apparatuses for the neural network computations have been fully specialized for certain particular network structures, which limits versatilities of the hardware acceleration apparatuses.

No effective solution has yet been proposed to solve the problem of poor versatilities of hardware acceleration apparatuses for neural network computations in the prior art.

### SUMMARY

In view of the aforesaid problem of poor versatilities of hardware acceleration apparatuses for neural network computations in the prior art, embodiments of the present disclosure provide a hardware acceleration apparatus and an acceleration method for a neural network computation, which could solve the aforesaid problem.

Embodiments of the present disclosure provide following solutions.

In a first aspect, provided is a hardware acceleration apparatus for a neural network computation. The hardware acceleration apparatus includes a memory module, a parsing module, and a plurality of functional modules. The parsing module is electrically connected to each of the functional modules and is configured to receive an instruction sequence predetermined based on a size of the memory module and data required for the neural network computation, parse the instruction sequence to acquire multiple types of operation instructions, and issue to each of the functional modules an operation instruction of a corresponding type among the multiple types of operation instructions. Each of the functional modules is electrically connected to the memory module and the parsing module and is configured to perform a corresponding operation for the neural network computation in response to receiving the operation instruction of the corresponding type. The memory module is electrically connected to each of the functional modules and is configured to cache the data required for the neural network computation.

In an embodiment, the multiple types of operation instructions at least include a loading instruction, a computation instruction, and a storage instruction; and the plurality of functional modules includes: a loading module electrically connected to an external storage, the memory module and the parsing module and configured to load the data required for the neural network computation from the external storage into the memory module in response to the loading instruction issued by the parsing module, where the data required for the neural network computation includes parameter data and feature map data; a computation module electrically connected to the memory module and the parsing module and configured to perform computation by reading the parameter data and the feature map data from the memory module in response to the computation instruction issued by the parsing module and to return a computation result to the memory module; and a storage module electrically connected to the external storage, the memory module and the parsing module and configured to store the computation result from the memory module back into the external storage in response to the storage instruction issued by the parsing module.

In an embodiment, the computation instruction includes a first computation instruction and a second computation instruction, and the computation module includes: at least one first computation unit that includes a plurality of multiply-accumulate units and is configured to receive the first computation instruction issued by the parsing module, perform convolutional computation and/or matrix multiplication computation by reading the parameter data and the feature map data from the memory module according to the first computation instruction to acquire an intermediate computation result, and return the intermediate computation result to the memory module; and at least one second computation unit that includes a plurality of arithmetic computation units and logic computation units and is configured to receive the second computation instruction issued by the parsing module, perform activation computation and/or pooling computation by reading the intermediate computation result from the memory module according to the second computation instruction to acquire the computation result, and return the computation result to the memory module.

In an embodiment, each of the functional modules is further configured to send an end-of-execution tag to the parsing module after execution of the operation instruction of the corresponding type is completed; and the parsing module is further configured to parse the instruction sequence to acquire a dependency relationship between the plurality of functional modules, and issue to each of the functional modules the operation instruction of the corresponding type in an order based on the dependency relationship and the end-of-execution tag as received.

In an embodiment, the hardware acceleration apparatus further includes a control module electrically connected to each of the functional modules and configured to control a working state of each of the functional modules in the hardware acceleration apparatus, the working state including at least an on state and an off state.

In an embodiment, the hardware acceleration apparatus further includes a data management module electrically connected to the memory module and the computation module and configured to move data cached in the memory module to the computation module and move output data of the computation module to the memory module.

In an embodiment, the hardware acceleration apparatus further includes a data interaction module electrically connected to a plurality of first computation units and configured to enable data interaction between the plurality of first computation units.

In an embodiment, the loading module is further configured to perform decompression processing on compressed data to be loaded into the memory module; and the storage module is further configured to perform compression processing on uncompressed data read from the memory module to be stored in the external storage.

In an embodiment, the instruction sequence is predetermined by disassembling the neural network computation into a plurality of sub-computations based on the size of the memory module and the data required for the neural network computation and determining the instruction sequence based on respective data required for the plurality of sub-computations resulting from the disassembling and a dependency relationship between the plurality of sub-computations; and the parsing module is further configured to parse the instruction sequence to acquire operation instructions corresponding to the plurality of sub-computations, and issue to each of the functional modules the operation instruction of the corresponding type in an order based on the dependency relationship between the plurality of sub-computations.

In an embodiment, the instruction sequence is predetermined based on the size of the memory module, the data required for the neural network computation, a storage space utilization rate of the memory module and a requirement for computation bandwidth.

In an embodiment, a storage object of each storage space in the memory module is adjustably configured according to the instruction sequence.

In a second aspect, provided is an acceleration method for a neural network computation. The acceleration method includes: receiving an instruction sequence predetermined based on a size of a memory module and data required for the neural network computation, and parsing the instruction sequence to acquire multiple types of operation instructions; and sequentially performing corresponding operations for the neural network computation based on the multiple types of operation instructions.

In an embodiment, the multiple types of operation instructions at least include a loading instruction, a computation instruction, and a storage instruction; and the acceleration method further includes: loading the data required for the neural network computation from an external storage into the memory module in response to the loading instruction issued by the parsing module, where the data required for the neural network computation includes parameter data and feature map data; performing computation by reading the parameter data and the feature map data from the memory module in response to the computation instruction issued by the parsing module, and returning a computation result to the memory module; and storing the computation result from the memory module back into the external storage in response to the storage instruction issued by the parsing module.

In an embodiment, the computation instruction includes at least one first computation instruction and at least one second computation instruction; and the acceleration method further includes: receiving the first computation instruction issued by the parsing module, performing convolutional computation and/or matrix multiplication computation by reading the parameter data and the feature map data from the memory module according to the first computation instruction to acquire an intermediate computation result, and returning the intermediate computation result to the memory module; and receiving the second computation instruction issued by the parsing module, performing activation computation and/or pooling computation by reading the intermediate computation result from the memory module according to the second computation instruction to acquire the computation result, and returning the computation result to the memory module.

In an embodiment, the acceleration method further includes generating an end-of-execution tag after execution of an operation instruction of a corresponding type is completed; and parsing the instruction sequence to acquire a dependency relationship between the plurality of functional modules, and generating operation instructions of corresponding types in an order based on the dependency relationship and the end-of-execution tag.

In an embodiment, the acceleration method further includes controlling a working state corresponding to each type of operation instruction, the working state including at least an on state and an off state.

In an embodiment, the acceleration method further includes moving data cached in the memory module to perform the computation, and moving output data from the computation to the memory module.

In an embodiment, the acceleration method further includes performing data interactions between respective data corresponding to at least one first computation instruction.

In an embodiment, the acceleration method further includes: decompressing compressed data to be loaded into the memory module; and compressing uncompressed data read from the memory module to be stored in the external storage.

In an embodiment, the acceleration method further includes: disassembling the neural network computation into a plurality of sub-computations based on the size of the memory module and the data required for the neural network computation; determining the instruction sequence based on respective data required for the plurality of sub-computations resulting from the disassembling and a dependency relationship between the plurality of sub-computations; parsing the instruction sequence to acquire operation instructions corresponding to the plurality of sub-computations; and generating the multiple types of operation instructions in an order based on the dependency relationship between the plurality of sub-computations.

In an embodiment, the acceleration method further includes predetermining the instruction sequence based on the size of the memory module, the data required for the neural network computation, a storage space utilization rate of the memory module and a requirement for computation bandwidth.

In an embodiment, the acceleration method further includes adjustably configuring a storage object of each storage space in the memory module according to the instruction sequence.

At least one of the aforesaid technical solutions adopted in embodiments of the present disclosure can achieve the following beneficial effects. The instruction sequence is predetermined based on the size of the memory module and the size of the data required for the neural network computation, and is parsed to regulate the respective functional tasks performed by the functional modules, thus enabling the entire neural network computation to be accelerated through the instructions adapted for hardware, such that the hardware acceleration apparatus is applicable to more types of or larger-scaled neural network computations.

It should be understood that the aforesaid description is a summary of the technical solutions of the present disclosure only for the purpose of facilitating a better understanding of technical means of the present disclosure so that the present disclosure could be implemented according to the description in the specification. Specific embodiments of the present disclosure are given below to render the above and other objects, features, and advantages of the present disclosure more clear.

### BRIEF DESCRIPTION OF THE DRAWINGS

By reading the following details of the exemplary embodiments below, a person of ordinary skill in the art may understand the advantages and benefits described herein and other advantages and benefits. The accompanying drawings are only for the purpose of illustrating exemplary embodiments and are not intended to be any limitation of the present disclosure. Further, the same reference sign is used to indicate the same element throughout the accompanying drawings.

FIG. 1 is a schematic structural diagram of a hardware acceleration apparatus for a neural network computation according to an embodiment of the present disclosure;

FIG. 2 is a schematic structural diagram of a hardware acceleration apparatus for a neural network computation according to another embodiment of the present disclosure;

FIG. 3 is a schematic structural diagram of a hardware acceleration apparatus for a neural network computation according to still another embodiment of the present disclosure;

FIG. 4 is a schematic diagram for illustrating disassembling of a neural network computation according to an embodiment of the present disclosure; and

FIG. 5 is a schematic flowchart of an acceleration method for a neural network computation according to an embodiment of the present disclosure.

In the accompanying drawings, the same or corresponding reference signs designate the same or corresponding parts.

### DETAILED DESCRIPTION

Exemplary embodiments of the present disclosure will be described below in more details with reference to the accompanying drawings. Although the accompanying drawings illustrate exemplary embodiments of the present disclosure, it should be understood that the present disclosure can be implemented in various ways and should not be construed to be limited to embodiments described herein. Rather, these embodiments are provided to facilitate more thorough understanding of the present disclosure so that the scope of the present disclosure could be conveyed to a person of ordinary skill in the art.

In the present disclosure, it should be understood that terms such as “include” or “have” are intended to indicate the existence of the characteristics, digits, steps, actions, components, parts disclosed by the specification or any combination thereof, without excluding the existence of one or more other characteristics, digits, steps, actions, components, parts or any combination thereof.

Furthermore, it should be noted that the embodiments of the present disclosure and features therein may be combined with each other in any manner in case of no conflict. The present disclosure will be described in detail below with reference to the accompanying drawings and embodiments.

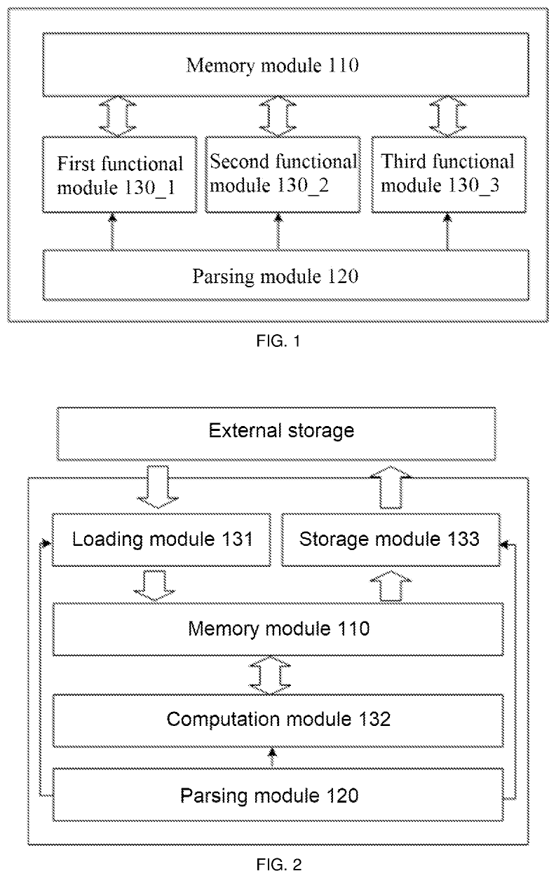

FIG. 1 is a schematic structural diagram of a hardware acceleration apparatus according to an embodiment of the present disclosure. The hardware acceleration apparatus is applicable to neural network computations.

As shown in FIG. 1, the hardware acceleration apparatus may at least include a memory module 110, a parsing module 120, and a plurality of functional modules (e.g., 130_1, 130_2 and 130_3). Each of the functional modules (e.g., 130_1, 130_2 and 130_3) is electrically connected to the memory module 110 and the parsing module 120. The memory module 110 is configured to cache the data required for the neural network computation. The parsing module 120 is configured to receive the instruction sequence, where the instruction sequence may be predetermined according to the size of the memory module and the data required for the neural network computation. The parsing module 120 parses the received instruction sequence that is externally transmitted, to acquire multiple types of operation instructions, where the multiple types of operation instructions may correspond to the functional modules respectively. The parsing module 120 then issues to each of the functional modules an operation instruction of a corresponding type among the multiple types of operation instructions. Each functional module performs a corresponding operation for the neural network computation in response to receiving the operation instruction of the corresponding type, i.e., the functional modules perform the respective functional tasks.

In an example, as shown in FIG. 1, the plurality of functional modules may include a first functional module 130_1, a second functional module 130_2, and a third functional module 130_3, which may be configured to perform common operations in neural network computations, such as convolution, activation, pooling, batch normalization, and so forth. Different neural network computations have different combinations of computation functions. Thus, in order for the hardware acceleration apparatus to be better applicable to different neural networks, the instruction sequence may be predetermined by software based on the size of the memory module and the data required for the neural network computation, for example, a large-scaled neural network computation is divided into the forms supported by the accelerator, or a combined and complex computation is disassembled into a group of simple computations supported by the accelerator, and the overall neural network computation is accelerated by means of the instruction sequence adapted for hardware. The parsing module 120 mainly serves to parse the received instruction sequence to acquire the operation instruction corresponding to each functional module, and distribute different types of operation instructions to different functional modules, thus enabling regulation of the order of executions of the functional modules that has a dependency relationship, thereby ensuring parallel operations of the various functional modules within the hardware to the great extent while ensuring executions of the instructions with no error.

Therefore, by predetermining the instruction sequence based on the size of the memory module and the size of the data required for the neural network computation and parsing the instruction sequence to regulate respective functional tasks performed by the functional modules, the entire neural network computation could be accelerated through the instructions adapted for hardware, thus the hardware acceleration apparatus is applicable to more types of or larger-scaled neural network computations.

The hardware acceleration apparatus according to this embodiment is applicable to various types of neural network computation models, which for example include, but not limited to, AlexNet, VGG16, ResNet-50, InceptionV3, InceptionV4, MobilenetV2, DenseNet, YOLOv3, MaskRCNN, Deeplabv3+, etc.

In some embodiments, the instruction sequence may be predetermined based on the storage space utilization rate of the memory module and the requirement for computation bandwidth in addition to the size of the memory module and the data required for the neural network computation. Therefore, excessively high or low utilization of storage space and bandwidth can be avoided.

In some embodiments, a storage object of each storage space in the memory module may be adjustably configured according to the instruction sequence. In other words, instead of being fixedly configured to store a certain type of data (e.g., the intermediate computation result), each storage space in the memory module may be adaptively adjusted according to actual computational needs. For example, at the beginning of the neural network computation, when the amount of feature map data is large and the amount of weight data is small, a larger space can be allocated to store the feature map data and a smaller space can be allocated to store the weights. After that, when the amount of feature map data gradually decreases and the amount of weight data gradually increases, the space for storing feature map can be reduced and the space for storing weight can be expanded accordingly. Through adaptive adjustment, wasting of the storage space in the memory module can be avoided.

In some embodiments, the multiple types of operation instructions at least include a loading instruction, a computation instruction, and a storage instruction.

As shown in FIG. 2, the functional modules may include a loading module 131, a computation module 132, and a storage module 133. The loading module 131 is electrically connected to the external storage, the memory module 110, and the parsing module 120; the computation module 132 is electrically connected to the memory module 110 and the parsing module 120; and the storage module 133 is electrically connected to the external storage, the memory module 110, and the parsing module 120. The loading module 131 is configured to load the data required for the neural network computation from the external storage into the memory module 110 in response to the loading instruction issued by the parsing module 120, where the data required for the neural network computation includes parameter data and feature map data. The computation module 132 is configured to perform the neural network computation by reading the parameter data and the feature map data from the memory module 110 in response to the computation instruction issued by the parsing module 120, and return the computation result to the memory module 110. The storage module 133 is configured to store the computation result of the neural network computation from the memory module 110 back into the external storage in response to the storage instruction issued by the parsing module 120.

In some embodiments, the computation instruction may include a first computation instruction and a second computation instruction.

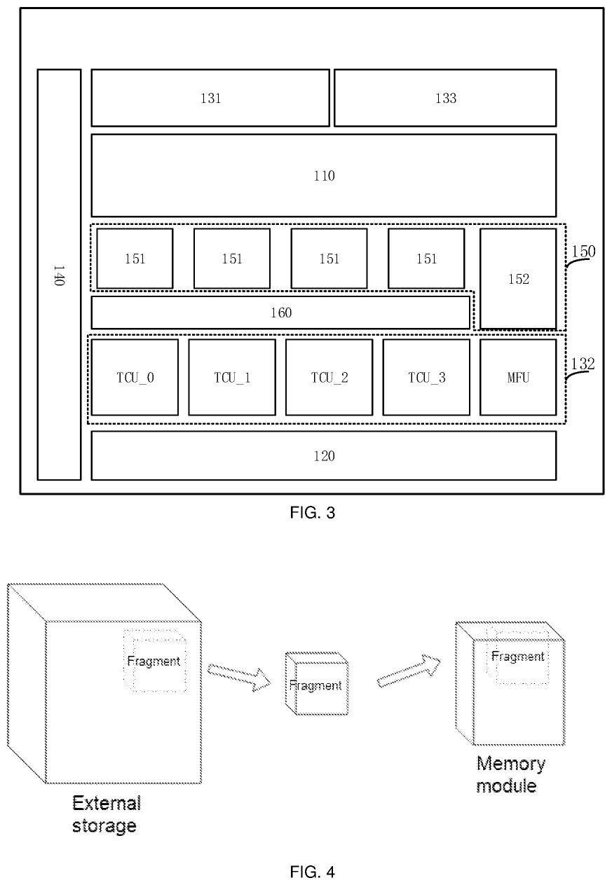

As shown in FIG. 3, the computation module 132 may specifically include a first computation unit TCU and a second computation unit MFU. There may be a plurality of first computation units included, for example, TCU_0, TCU_1, TCU_2, and TCU_3. Each first computation unit TCU may include a plurality of multiply-accumulate units, such as a computation array organized by 12×16 multiply-accumulate units, and be configured to receive a first computation instruction issued by the parsing module 120, perform convolutional computation and/or matrix multiplication computation by reading the parameter data and the feature map data from the memory module 110 according to the first computation instruction to acquire an intermediate computation result, and return the intermediate computation result to the memory module 110. The second computation unit MFU may include a plurality of arithmetic computation units and logic computation units, and be configured to receive the second computation instruction issued by the parsing module 120, perform activation and/or pooling computations by reading the intermediate computation result from the memory module 110 according to the second computation instruction to acquire the computation result, and return the computation result to the memory module 110.

In some embodiments, each functional module may be further configured to send an end-of-execution tag to the parsing module 120 after execution of the operation instruction of the corresponding type is completed; and the parsing module 120 is further configured to parse the instruction sequence to acquire a dependency relationship between the plurality of functional modules, and issue to each of the functional modules the operation instruction of the corresponding type in an order based on the dependency relationship and the end-of-execution tag as received.

In an example, a simple computation process may include following steps. First, the loading module 131 loads specified data from the external storage into the memory module 110; afterwards, the computation module 132 acquires the specified data from the memory module 110 to perform the neural network computation, and stores the computation result back into the memory module 110; then, the storage module 133 reads the computation result from the memory module 110 and stores it back into the external storage. It can be seen that there is a dependency relationship between the loading module 131, the computation module 132 and the storage module 133. Based on this, in response to the loading instruction for the specified data, the loading module 131 loads the specified data from the external storage and stores it into the memory module 110, and issues an end-of-loading tag to the parsing module 120 after completing the loading task for the specified data. After receiving the end-of-loading tag, the parsing module 120 issues a computation instruction to the computation module 132 according to the dependency relationship. The computation module 132 issues an end-of-computation tag to the parsing module 120 after performing the computation task on the specified data. After receiving the end-of-execution tag, the parsing module 120 issues a storage instruction to the storage module 133 based on the dependency relationship. Therefore, the reliability of the hardware operation can be further ensured.

In some embodiments, the apparatus may further include a control module 140 electrically connected to each functional module and configured to control a working state of each functional module in the hardware acceleration apparatus, the working state including an on state and an off state. Based on this, configuration information may be fed into the control module 140 via a configuration interface by software to accomplish hardware and software interactive communication.

In some embodiments, referring to FIG. 3, the apparatus may further include a data management module 150 which is electrically connected to the memory module 110 and the computation module 132 and includes a plurality of data management units 151 and 152, where the data management unit 151 is configured to move data cached in the memory module 110 to the first computation unit TCU and move output data of the first computation unit TCU to the memory module 110. The data management unit 152 is configured to move data cached in the memory module 110 to the second computation unit MFU and move output data of the second computation unit MFU to the memory module 110.

In some embodiments, the apparatus may further include a data interaction module 160 electrically connected to the plurality of first computation units and configured to enable data interaction between the plurality of first computation units (e.g., TCU_0, TCU_1, TCU_2, and TCU_3).

In some embodiments, the loading module 131 is further configured to perform decompression processing on compressed data to be loaded into the memory module 110; and the storage module is further configured to perform compression processing on the uncompressed data read from the memory module 110 to be stored in the external storage. Therefore, the bandwidth for data interaction with the external storage can be saved, and the cost of data interaction can be reduced.

In some embodiment, referring to FIG. 3, in order to provide the versatility of the hardware acceleration apparatus and further enhance its acceleration capability, the instruction sequence can be predetermined by disassembling the neural network computation into a plurality of sub-computations based on the size of the memory module 110 and the data required for the neural network computation and determining the instruction sequence based on respective data required for the plurality of sub-computations resulting from the disassembling and a dependency relationship between the plurality of sub-computations. Based on this, the parsing module 120 is further configured to parse the instruction sequence to acquire operation instructions corresponding to the plurality of sub-computations, and issue to each of the functional modules the operation instruction of the corresponding type in an order based on the dependency relationship between the plurality of sub-computations.

The dependency relationship between the plurality of sub-computations described above may include that the input data of one or more sub-computations is dependent on the output data of one or more other sub-computations.

In an example, as shown in FIG. 4, due to the limited storage space of the memory module 110, a large-scaled neural network computation cannot be provided with a sufficient storage space. In view of this, an external software may be used to divide the input feature map for computation into a number of fragments based on the size of the storage space of the memory module 110 and generate the instruction sequence corresponding to each fragment, for example including a series of instructions such as a loading instruction, a computation instruction, and a storage instruction, where each fragment is a multi-dimensional data block with dimensions including width, height, and number of channels. Referring to FIG. 3, using the external software, configuration information may firstly be sent to the control module 140 via the configuration interface, thereby initiating the acceleration apparatus to accelerate the sequential reading of the instruction sequence from the external storage module. Afterwards, the parsing module 120 parses the read instruction sequence and distributes the resulting instructions to different functional modules, and the different functional modules perform corresponding operations according to their respective instructions as received. For example, after receiving a loading instruction for a certain fragment, the loading module 131 reads data of the fragment from the external storage unit, writes it into a designated storage area of the memory module 110 requested by the loading instruction, and reports the end-of-loading tag to the parsing module 120 upon completion of the loading task. The parsing module 120 sends a computation instruction for the fragment to the computation module 132 after receiving the end-of-loading tag of the fragment. The computation module 132 then performs the computation by reading the corresponding fragment data from the designated storage area of the memory module 110 via the data management module 150, writes the computation result back into another storage area of the memory module 110 designated by the computation instruction via the data management module 150, and reports the end-of-computation tag to the parsing module 120 upon completion of the computation task. After receiving the storage instruction corresponding to the fragment, the storage module 133 reads the computation result corresponding to the fragment from the memory module 110 and writes it into the designated storage area of the external storage requested by the storage instruction. The aforesaid instruction sequence involves movement, computation, and other actions for all fragments, so that the hardware performs cyclic operations according to the instructions, thereby ultimately completing the acceleration process of the entire neural network.

Based on the same technical concept, embodiments of the present disclosure also provide an acceleration method for a neural network computation, which is applicable to the hardware acceleration apparatus illustrated in FIG. 1, FIG. 2, or FIG. 3.

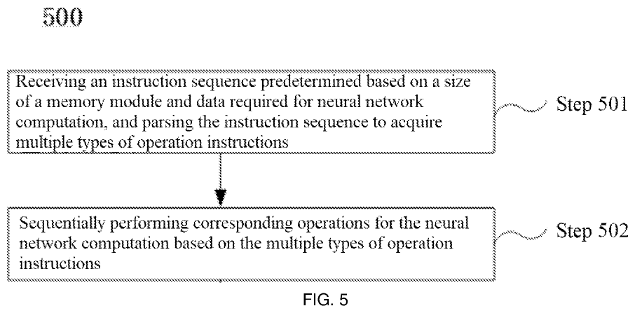

As shown in FIG. 5, the method may include following steps.

Step 501: an instruction sequence predetermined based on a size of a memory module and data required for the neural network computation is received, and the instruction sequence is parsed to acquire multiple types of operation instructions.

Step 502: corresponding operations for the neural network computation are sequentially performed based on the multiple types of operation instructions.

In an embodiment, the multiple types of operation instructions at least include a loading instruction, a computation instruction, and a storage instruction; and the method further includes: loading the data required for the neural network computation from an external storage into the memory module in response to the loading instruction issued by the parsing module, where the data required for the neural network computation includes parameter data and feature map data; performing computation by reading the parameter data and the feature map data from the memory module in response to the computation instruction issued by the parsing module, and returning a computation result to the memory module; and storing the computation result from the memory module back into the external storage in response to the storage instruction issued by the parsing module.

In an embodiment, the computation instruction includes at least one first computation instruction and at least one second computation instruction; and the method further includes: receiving the first computation instruction issued by the parsing module, performing convolutional computation and/or matrix multiplication computation by reading the parameter data and the feature map data from the memory module according to the first computation instruction to acquire an intermediate computation result, and returning the intermediate computation result to the memory module; and receiving the second computation instruction issued by the parsing module, performing activation computation and/or pooling computation by reading the intermediate computation result from the memory module according to the second computation instruction to acquire the computation result, and returning the computation result to the memory module.

In an embodiment, the method further includes: generating an end-of-execution tag after execution of an operation instruction of a corresponding type is completed; and parsing the instruction sequence to acquire a dependency relationship between the plurality of functional modules, and generating operation instructions of corresponding types in an order based on the dependency relationship and the end-of-execution tag.

In an embodiment, the method further includes controlling a working state corresponding to each type of operation instruction, the working state including at least an on state and an off state.

In an embodiment, the method further includes moving data cached in the memory module to perform the computation operation, and moving output data from the computation operation to the memory module.

In an embodiment, the method further includes performing data interactions between respective data corresponding to at least one first computation instruction.

In an embodiment, the method further includes: decompressing compressed data to be loaded into the memory module; and compressing uncompressed data read from the memory module to be stored in the external storage.

In an embodiment, the method further includes: disassembling the neural network computation into a plurality of sub-computations based on the size of the memory module and the data required for the neural network computation; determining the instruction sequence based on respective data required for the plurality of sub-computations resulting from the disassembling and a dependency relationship between the plurality of sub-computations; parsing the instruction sequence to acquire operation instructions corresponding to the plurality of sub-computations; and generating the multiple types of operation instructions in an order based on the dependency relationship between the plurality of sub-computations.

In an embodiment, the method further includes predetermining the instruction sequence based on the size of the memory module, the data required for the neural network computation, a storage space utilization rate of the memory module and a requirement for computation bandwidth.

In an embodiment, the method further includes adjustably configuring a storage object of each storage space in the memory module according to the instruction sequence.

It should be noted that the acceleration method in embodiments of the present disclosure is in one-to-one correspondence with the hardware acceleration apparatus in aforesaid embodiments in various terms, and can achieve the same effect and function, thus the details thereof will not be repeated here.

Although the spirit and principles of the present disclosure have been described with reference to several embodiments, it shall be understood that the present disclosure is not limited to the embodiments as disclosed, nor does the division of the aspects imply that the features in those aspects cannot be combined for benefit, such division being for convenience of presentation only. The present disclosure is intended to cover various modifications and equivalent arrangements included within the spirit and scope of the appended claims.

1. A hardware acceleration apparatus for a neural network computation, comprising a memory module, a parsing module and a plurality of functional modules, wherein
the parsing module is electrically connected to each of the functional modules and is configured to receive an instruction sequence predetermined based on a size of the memory module and data required for the neural network computation, parse the instruction sequence to acquire multiple types of operation instructions, and issue to each functional module an operation instruction of a corresponding type among the multiple types of operation instructions;
each of the functional modules is electrically connected to the memory module and the parsing module and is configured to perform a corresponding operation for the neural network computation in response to receiving the operation instruction of the corresponding type; and
the memory module is electrically connected to each of the functional modules and is configured to cache the data required for the neural network computation.

2. The hardware acceleration apparatus according to claim 1, wherein the multiple types of operation instructions at least comprise a loading instruction, a computation instruction, and a storage instruction; and the plurality of functional modules comprise:
a loading module electrically connected to an external storage, the memory module and the parsing module and configured to load the data required for the neural network computation from the external storage into the memory module in response to the loading instruction issued by the parsing module, wherein the data required for the neural network computation comprises parameter data and feature map data;
a computation module electrically connected to the memory module and the parsing module and configured to perform, in response to the computation instruction issued by the parsing module, computation by reading the parameter data and the feature map data from the memory module and to return a computation result to the memory module; and
a storage module electrically connected to the external storage, the memory module and the parsing module and configured to store the computation result from the memory module back into the external storage in response to the storage instruction issued by the parsing module.

3. The hardware acceleration apparatus according to claim 2, wherein the computation instruction comprises a first computation instruction and a second computation instruction, and the computation module comprises:
at least one first computation unit that comprises a plurality of multiply-accumulate units and is configured to receive the first computation instruction issued by the parsing module, perform convolutional computation and/or matrix multiplication computation by reading the parameter data and the feature map data from the memory module according to the first computation instruction to acquire an intermediate computation result, and return the intermediate computation result to the memory module; and
at least one second computation unit that comprises a plurality of arithmetic computation units and logic computation units and is configured to receive the second computation instruction issued by the parsing module, perform activation computation and/or pooling computation by reading the intermediate computation result from the memory module according to the second computation instruction to acquire the computation result, and return the computation result to the memory module.

4. The hardware acceleration apparatus according to claim 1, wherein
each of the functional modules is further configured to send an end-of-execution tag to the parsing module after execution of the operation instruction of the corresponding type is completed; and
the parsing module is further configured to parse the instruction sequence to acquire a dependency relationship between the plurality of functional modules, and issue to each of the functional modules the operation instruction of the corresponding type in an order based on the dependency relationship and the end-of-execution tag as received.

5. The hardware acceleration apparatus according to claim 1, further comprising:
a control module electrically connected to each of the functional modules and configured to control a working state of each of the functional modules in the hardware acceleration apparatus, the working state comprising at least an on state and an off state.

6. The hardware acceleration apparatus according to claim 2, further comprising:
a data management module electrically connected to the memory module and the computation module and configured to move data cached in the memory module to the computation module and move output data from the computation module to the memory module.

7. The hardware acceleration apparatus according to claim 3, further comprising:
a data interaction module electrically connected to a plurality of the first computation units and configured to enable data interaction between the first computation units.

8. The hardware acceleration apparatus according to claim 2, wherein
the loading module is further configured to perform decompression processing on compressed data to be loaded into the memory module; and
the storage module is further configured to perform compression processing on uncompressed data read from the memory module to be stored in the external storage.

9. The hardware acceleration apparatus according to claim 1, wherein
the instruction sequence is predetermined by disassembling the neural network computation into a plurality of sub-computations based on the size of the memory module and the data required for the neural network computation and determining the instruction sequence based on respective data required for the plurality of sub-computations resulting from the disassembling and a dependency relationship between the plurality of sub-computations; and
the parsing module is further configured to parse the instruction sequence to acquire operation instructions corresponding to the plurality of sub-computations, and issue to each of the functional modules the operation instruction of the corresponding type in an order based on the dependency relationship between the plurality of sub-computations.

10. The hardware acceleration apparatus according to claim 1, wherein the instruction sequence is predetermined further based on a storage space utilization rate of the memory module and a requirement for computation bandwidth.

11. The hardware acceleration apparatus according to claim 1, wherein
a storage object of each storage space in the memory module is adjustably configured according to the instruction sequence.

12. An acceleration method for a neural network computation, comprising:
receiving an instruction sequence predetermined based on a size of a memory module and data required for the neural network computation, and parsing the instruction sequence to acquire multiple types of operation instructions; and
sequentially performing corresponding operations for the neural network computation based on the multiple types of operation instructions.

13. The acceleration method according to claim 12, wherein the multiple types of operation instructions at least comprise a loading instruction, a computation instruction, and a storage instruction; and the acceleration method further comprises:
loading the data required for the neural network computation from an external storage into the memory module in response to the loading instruction issued by a parsing module, wherein the data required for the neural network computation comprises parameter data and feature map data;
performing, in response to the computation instruction issued by the parsing module, computation by reading the parameter data and the feature map data from the memory module, and returning a computation result to the memory module; and
storing the computation result from the memory module back into the external storage in response to the storage instruction issued by the parsing module.

14. The acceleration method according to claim 13, wherein the computation instruction comprises at least one first computation instruction and at least one second computation instruction, and the acceleration method further comprises:
receiving the first computation instruction issued by the parsing module, performing convolutional computation and/or matrix multiplication computation by reading the parameter data and the feature map data from the memory module according to the first computation instruction to acquire an intermediate computation result, and returning the intermediate computation result to the memory module; and
receiving the second computation instruction issued by the parsing module, performing activation computation and/or pooling computation by reading the intermediate computation result from the memory module according to the second computation instruction to acquire the computation result, and returning the computation result to the memory module.

15. The acceleration method according to claim 12, further comprising:
generating an end-of-execution tag after execution of an operation instruction of a corresponding type is completed; and
parsing the instruction sequence to acquire a dependency relationship between the plurality of functional modules, and generating operation instructions of corresponding types in an order based on the dependency relationship and the end-of-execution tag.

16. The acceleration method according to claim 12, further comprising:
controlling a working state corresponding to each type of operation instruction, the working state comprising at least an on state and an off state.

17. The acceleration method according to claim 13, further comprising:
moving data cached in the memory module to perform the computation operation, and moving output data from the computation operation to the memory module.

18. The acceleration method according to claim 14, further comprising:
performing data interactions between data corresponding to the at least one first computation instruction.

19. The acceleration method according to claim 13, further comprising:
decompressing compressed data to be loaded into the memory module; and
compressing uncompressed data read from the memory module to be stored in the external storage.

20. The acceleration method according to claim 12, further comprising:
disassembling the neural network computation into a plurality of sub-computations based on the size of the memory module and the data required for the neural network computation;
determining the instruction sequence based on respective data required for the plurality of sub-computations resulting from the disassembling and a dependency relationship between the plurality of sub-computations;
parsing the instruction sequence to acquire operation instructions corresponding to the plurality of sub-computations; and
generating the multiple types of operation instructions in an order based on the dependency relationship between the plurality of sub-computations.

21. (canceled)

22. (canceled)
